(19) United States
(12) Patent Application Publication
(10) Pub. No.: US 2014/0249967 A1
(43) Pub. Date: Sep. 4, 2014

(54) ORDER RECEPTION APPARATUS AND METHOD FOR TRASMITTING ORDER OF MENU ITEM BY THE SAME

(71) Applicant: TOSHIBA TEC KABUSHIKI KAISHA, Tokyo (JP)

(72) Inventor: Hiromasa Suzuki, Shizuoka-ken (JP)

(73) Assignee: TOSHIBA TEC KABUSHIKI KAISHA, Tokyo (JP)

(21) Appl. No.: 14/194,980

(22) Filed: Mar. 3, 2014

(30) Foreign Application Priority Data
Mar. 4, 2013 (JP) . 2013-042099

(51) Int. Cl. G06Q 30/06

(52) U.S. Cl. CPC G06Q 30/0635
USPC 705/26.81

(57) ABSTRACT

In accordance with one embodiment, an order reception apparatus, which displays a first selection screen for receiving an order of a menu item, comprises a reception module configured to receive a selection operation of the menu item on the first selection screen by a customer, a connection module configured to be connectable to an external apparatus, and a transfer module configured to transfer a content relating to the menu item the selection of which is received by the reception module on the first selection screen to the external apparatus connected with the connection module.

### CROSS-REFERENCE TO RELATED APPLICATION

This application is based upon and claims the benefit of priority from Japanese Patent Application No. 2013-042099, filed Mar. 4, 2013, the entire contents of which are incorporated herein by reference.

### FIELD

Embodiments described herein relate to an order reception apparatus and a method for transmitting order of a menu item by the order reception apparatus.

### BACKGROUND

Conventionally, an order system is introduced in a store such as a pub. As a basic function, the order system carries out a processing in which an order data (including a table code, menu code and the like) wirelessly sent from an order reception apparatus operated by a customer is transmitted to an order station, and an order entry processing is executed in the order station. While carrying out the order entry processing, for example, the order station further sends an instruction of printing and issuing an order slip to a kitchen printer, and also sends the order data to a POS terminal.

### BRIEF DESCRIPTION OF THE DRAWINGS

FIG. 1 is a system constitution diagram schematically illustrating the whole constitution of an order entry system according to an embodiment;

FIG. 2 is a block diagram illustrating an electric connection of an order reception apparatus;

FIG. 3 is a block diagram illustrating an electric connection of an order station;

FIG. 4 is a front view illustrating an example of a category selection screen of the order reception apparatus;

FIG. 5 is a front view illustrating an example of a menu selection screen of the order reception apparatus;

FIG. 6 is a front view illustrating an example of a menu detail screen of the order reception, apparatus;

FIG. 7 is a front view illustrating an example of a content selection screen of the order reception apparatus; and

FIG. 8 is a flowchart illustrating one example of a content transfer processing of the order reception apparatus.

### DETAILED DESCRIPTION

In accordance with one embodiment, an order reception apparatus, which displays a first selection screen for receiving an order on a menu item, comprises a reception module configured to receive a selection operation of the menu item on the first selection screen by a customer, a connection module configured to be connectable to an external apparatus, and a transfer module configured to transfer a content relating to the menu item the selection of which is received by the reception module on the first selection screen to the external apparatus connected with the connection module.

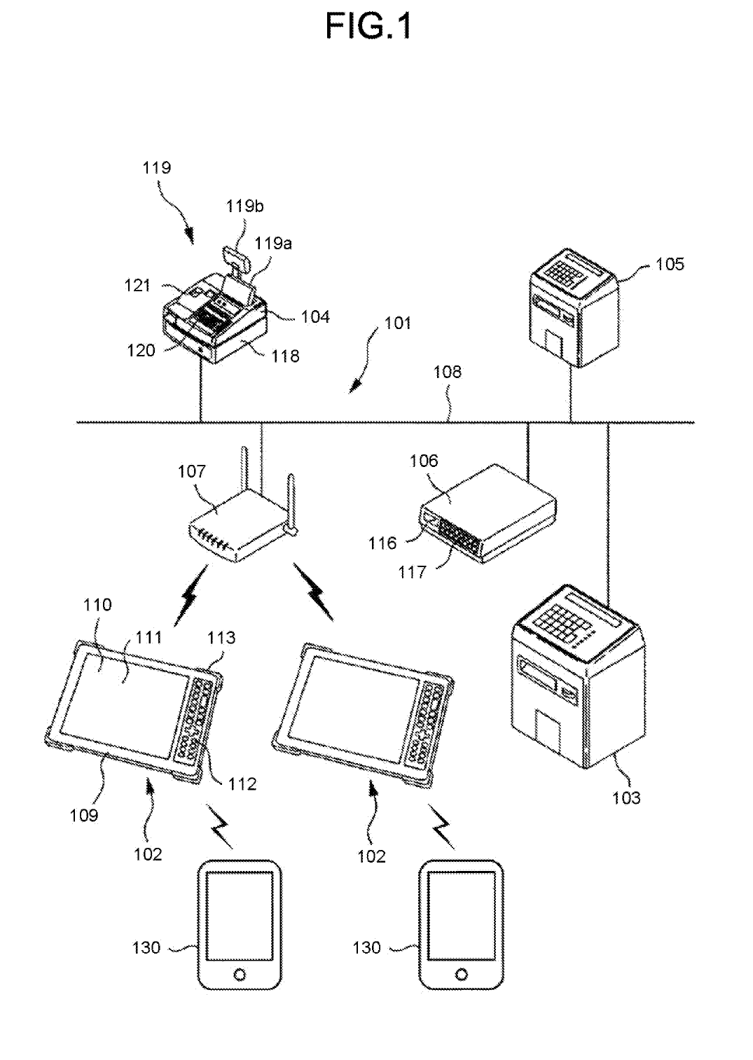

The present embodiment is described with reference to FIG. 1 to FIG. 8. FIG. 1 is a system constitution diagram schematically illustrating the whole constitution of an order entry system 101 according to the embodiment. The order entry system 101 of the present embodiment is introduced into a pub.

As shown in FIG. 1, the order entry system 101 comprises a plurality of order reception apparatuses 102 which are used by customers, a kitchen printer 103 arranged in a kitchen, a POS terminal 104 arranged on a checkout counter as a commodity sales data processing apparatus, a customer check printer 105 arranged at the hall of the pub, an order station 106, arranged at the backyard of the pub, which serves as a server for controlling the whole order entry system 101, and the like. The order reception apparatus 102 has a communication function of carrying out wireless communication with terminal devices 130 respectively carried by customers. No specific limitation is given to the communication function but, for example, technology relating to Bluetooth registered trademark), an infrared ray communication and the like can be used.

The order station 106 comprises an LCD 116 and a keyboard 117, and is capable of carrying out management of an order data wirelessly sent from each order reception apparatus 102.

The POS terminal 104 is arranged on a drawer 118 which stores coins and bills in such a manner that coins and bills can be taken out from or put in the drawer freely. The DOS terminal 104 comprises two displays 119 (119a, 119b) for operator and customer, an input device 120 including a keyboard and a mode selection key, and a receipt printer 121. The displays 119 and the input device 120 constitute a user interface which has an information input function by a user and an information output function for a user.

Next, the order reception apparatus 102 is described.

The order reception apparatus 102 carries out wireless-communication with the order station 106 through a radio repeater or router 107 which is arranged at the ceiling of the hall. The kitchen printer 103, the DOS terminal 104 and the customer check printer 105 are connected with the order station 106 through a LAN cable 108 to make communication with the order station 106 freely.

The order reception apparatus 102 receives input of a table code for specifying a table, a menu code for specifying a menu item and the quantity thereof. The order reception apparatus 102 generates an order data in which the table code is associated with the menu code and the quantity thereof. The order data generated by the order reception apparatus 102 is sent to the order station 106, and then further sent from the order station 106 to the kitchen printer 103, the POS terminal 104 and the customer check printer 105, respectively. The kitchen printer 103 and the customer check printer 105 respectively print contents of the received order data on a slip to issue the slip. The slip issued by the kitchen printer 103 is a cooking instruction slip for instructing the ordered menu item to a cook in the kitchen. The slip issued by the customer check printer 105 is handed over to a customer after the ordered commodity is served to the customer. The kitchen printer 103 and the customer check printer 105 have the same basic structure. The POS terminal 104 executes a sales data processing including a checkout processing based on the order data of the customer.

The order reception apparatus 102 includes a main body housing 109 having a certain thickness. At one of the surfaces (front surface) of the main body housing 109, an LCD (Liquid Chrystal Display) 111 having a touch panel 110 acting as a user interface is arranged, and at the right hand side of the front surface, a keyboard 112 serving as a user interface is arranged. The LCD 111 functioning as a display section provides information for a customer who uses the order reception apparatus 102. The touch panel 110 functions as a touch-input section to which information is input by detecting whether or not an image displayed on the LCD 111 is touched. The keyboard 112 includes numeric keys, a cross key and the like, and constitutes an operation section together with the touch panel 110. Further, a corner bumper 113 made of an impact resistant material is respectively arranged at corner portions of the main body housing 109. With the corner bumper 113, the impact resistance of the order reception apparatus 102 can be improved if it is slipped down from hands, accidentally.

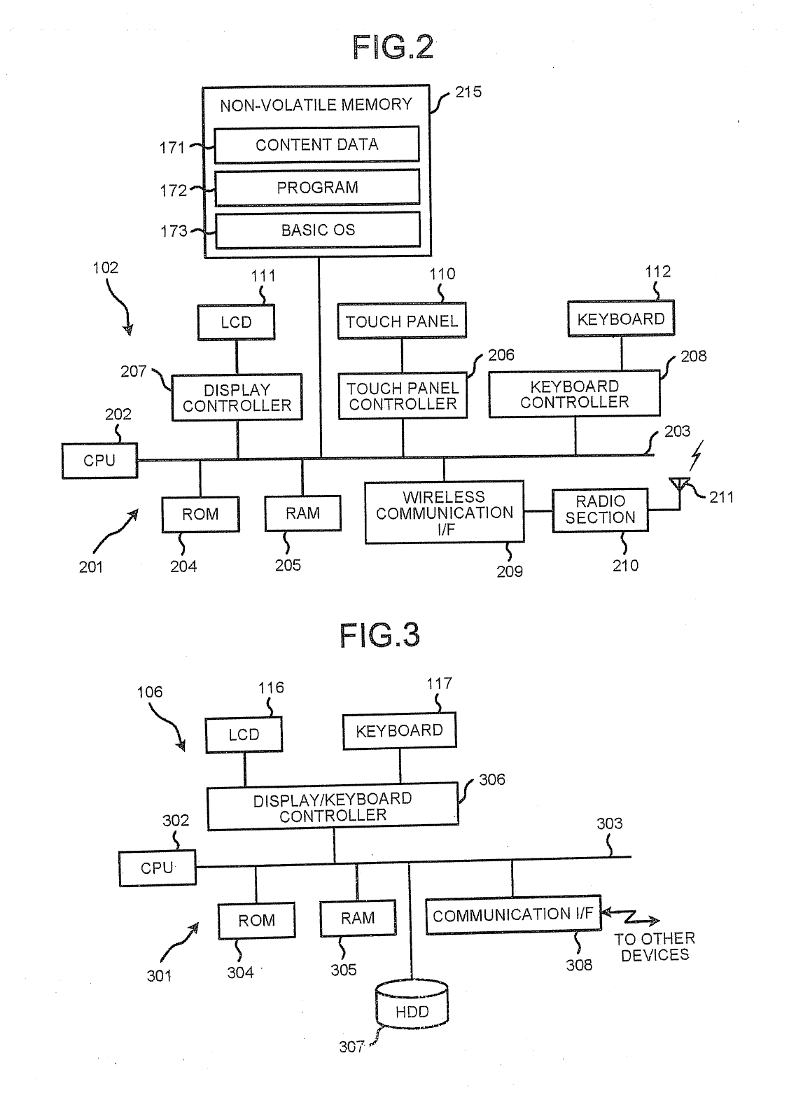

FIG. 2 is a block diagram illustrating the electric connection of the order reception apparatus 102. As shown in FIG. 2, the order reception apparatus 102 comprises a microcomputer 201 which controls each section. The microcomputer 201 is constituted by connecting, through a bus line 203, a CPU 202 intensively controlling each section with a ROM 204 for storing fixed or basic information such as a control program in advance, a RAM 205 functioning as a work area for temporarily storing various data in a rewritable manner, and a non-volatile memory 215 which stores data in a rewritable manner and keeps the stored data without power. Therefore, the microcomputer 201 constitutes an information processing section for executing an information processing.

A touch panel controller 206, a display controller 207, a keyboard controller 208, a wireless communication interface 209 and a radio section 210 are connected with the microcomputer 201 through the bus line 203.

The touch panel controller 206 acquires an input signal from the touch panel 110 into the microcomputer 201. The display controller 207 drives the LCD 111 based on the image data, and controls the LCD 111 to display an image according to the image data on the LCD 111. The keyboard controller 208 acquires an input signal from the keyboard 112 into the microcomputer 201. The wireless communication interface 209 controls the radio section 210. The radio section 210 executes wireless communication with the radio repeater 107 through an antenna 211. Various information such as the order data input in the order reception apparatus 102 is sent to the radio repeater 107 from the radio section 210. In this case, the destination of the order data is set to the order station 106. If the input information is the order data, the order data is wirelessly sent towards the order station 106. Thus, the function of inputting the order data through the operation on the operation section such as the touch panel 110 or the keyboard 112, and the function of wirelessly sending the input order data towards the order station 106 are executed. Further, the order reception apparatus 102 is able to execute a wireless communication with the terminal apparatus 130 of a customer, using the same functions as described above.

Various data including, for example, a basic OS 173, a program 172 for various processing in the order reception apparatus 102, and a content data 171 are stored in the non-volatile memory 215. The content data 171 retains, in association with a menu code, a menu photograph, a menu item name, a unit price, a motion picture or animation, a recipe, foodstuffs information, an advertisement and the like. All or part of the basic OS 173, the program 172 and the content data 171 are copied to the PAM 205 when the order reception apparatus 102 is started. The microcomputer 201 of the order reception apparatus 102 executes various processing according to the basic OS 173 and the program 172.

The electric connection of the order station 106 is briefly described. FIG. 3 is a block diagram illustrating the electric connection of the order station 106. As shown in FIG. 3, the order station 106 comprises a microcomputer 301 which controls each section. The microcomputer 301 is constituted by connecting, through a bus line 303, a CPU 302 intensively controlling each section with a ROM 304 for storing fixed or basic information such as a control program in advance and a RAM 305, functioning as a work area, which stores various data in a rewritable manner. Therefore, the microcomputer 301 constitutes an information processing section for executing an information processing. All or part of the RAM 305 is a non-volatile memory.

A display/keyboard controller 306, an HDD 307 and a communication interface 308 are connected with the microcomputer 301 through the bus line 303.

The display/keyboard controller 306 drives the LCD 116 based on the image data to control display of an image according to the image data on the LCD 116, and furthermore, acquires an input signal from the keyboard 117 into the microcomputer 301. The communication interface 308 is able to carry out, through the LAN cable 108, data communication with other devices such as the kitchen printer 103, the POS terminal 104, the customer check printer 105 and the radio repeater 107.

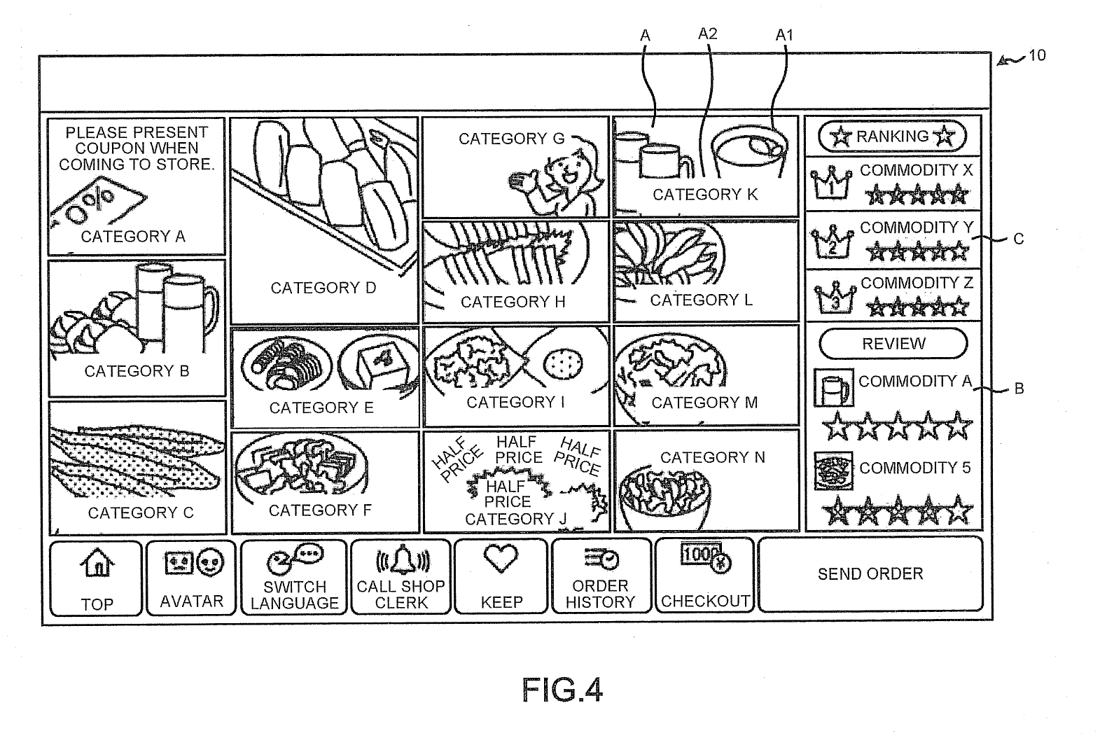

FIG. 4 is a front view illustrating an example of a category selection screen 10 of the order reception apparatus 102. The category selection screen 10 shown in FIG. 4 is displayed at an initial stage. The category selection screen 10 includes a category selection display A, a review display B and a popularity ranking display C.

The category selection display A includes a category photograph A1 and a category name A2 for each category.

The review display B displays the degree of the review (evaluation) of the ordered menu by customers with the number of asterisks and the review display B is displayed in an automatic scroll manner according to the order sequence. In the review display B of the present embodiment, the menu of which the review (evaluation) is not input by the customers is displayed at the top of the list, thereby urging the customer to input the review (evaluation) In this way, an evaluation display module of displaying the degree of the input evaluation on the LCD 111 in association with a corresponding menu (commodity item) is constituted.

The popularity ranking display C displays the result of the ranking obtained by summing up the review (evaluation) from customers, and the popularity ranking display C is displayed in an automatic scroll manner according to the ranking sequence.

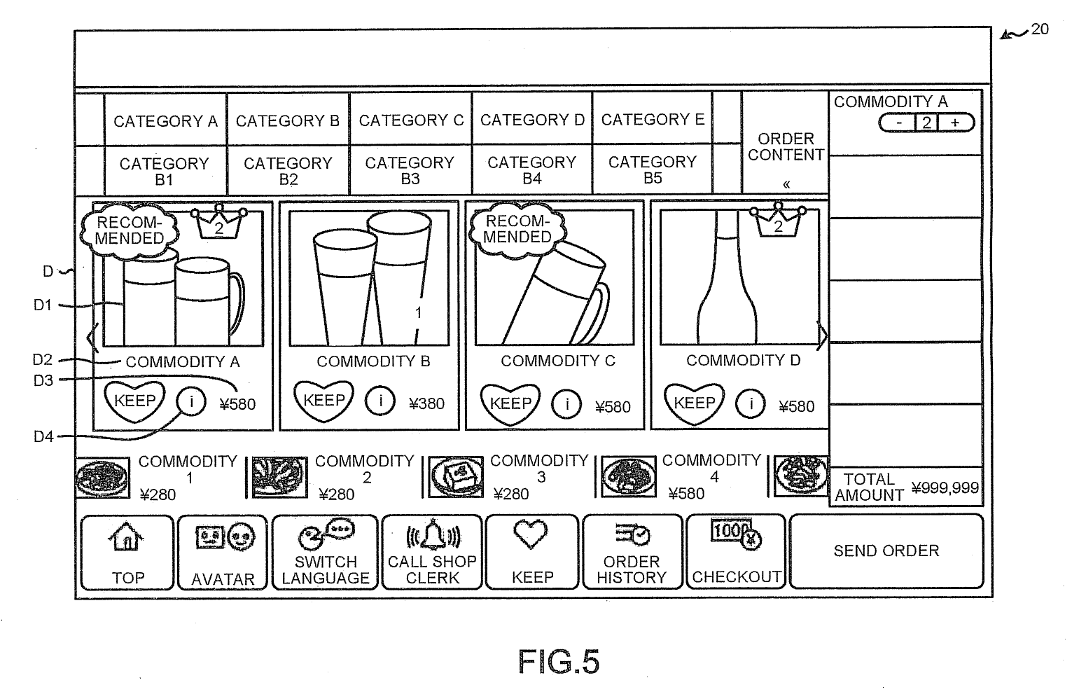

If a customer selects the category selection display A, the microcomputer 201 of the order reception apparatus 102 displays the menu of a corresponding category. In this way, a menu selection screen 20 (refer to FIG. 5) described later is displayed on the LCD 111.

FIG. 5 is a front view illustrating an example of the menu selection screen 20 of the order reception apparatus 102. The menu selection screen 20 includes a menu selection display D.

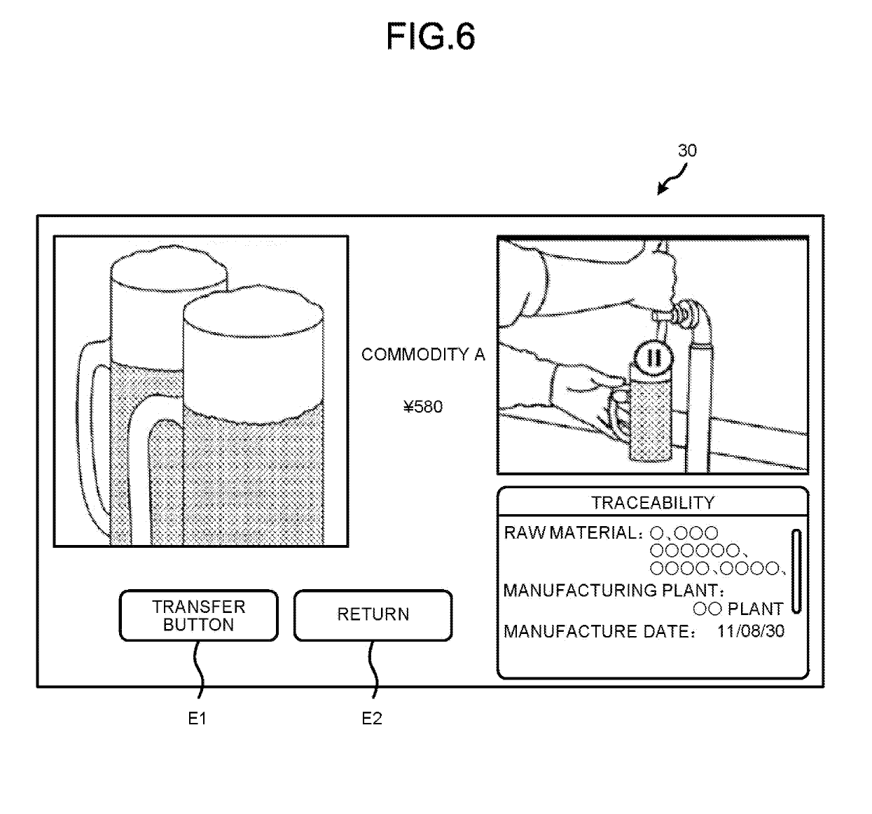

The menu selection display D is a first area which includes a menu photograph D1, a menu item name D2, a unit price D3 and a menu information D4 in each menu item of a group contained in a specific category. The menu information D4 serves as an operator for displaying detailed information of a corresponding menu item. If a selection of the menu information. D4 is received, the microcomputer 201 of the order reception apparatus 102 displays the detailed information of the corresponding menu item on the LCD 111 (refer to FIG. 6)

FIG. 6 is a front view illustrating an example of a menu detail screen 30 of the order reception apparatus 102. The menu detail screen 30 includes an animation showing traceability information and a cooking method as a content thereof in addition to an item name, a price and the like of the corresponding menu item. The contents included in the menu detail screen 30 are not limited to this, and the contents may also include a recipe, foodstuff information, an advertisement and the like.

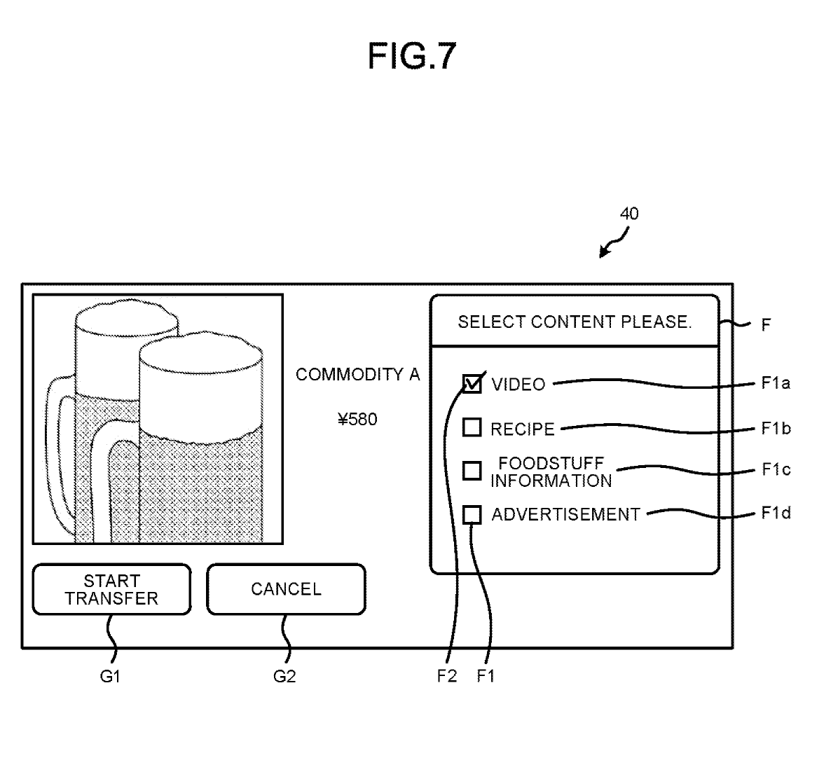

Further, the menu detail screen 30 includes a transfer button E1 and a return button E2. The transfer button E1 is an operator for instructing the transfer of the content. If a selection of the transfer button E1 is received, the microcomputer 201 of the order reception apparatus 102 displays a selection screen of the content contained in the menu detail screen 30 on the LCL 111 (refer to FIG. 7). The return button E2 is an operator for instructing an operation of returning to the menu selection screen 20. If a selection of the return button E2 is received, the microcomputer 201 of the order reception apparatus 102 displays the menu selection screen 20 on the LCD 111.

FIG. 7 is a front view illustrating an example of a content selection screen 40 of the order reception apparatus 102. The content selection screen 40 includes a content selection display F, a transfer start button G1 and a cancel button G2.

The content selection display F displays each piece of contents contained in the menu detail screen 30 in a selectable manner. An animation F1a, a recipe F1b, foodstuff information F1c, an advertisement F1d are exemplified as a content. The contents are respectively assigned to checkboxes F1, and thus the content desired to be transferred is selected by selecting the corresponding checkbox F1. If a selection operation on one checkbox F1 is carried out, the microcomputer 201 of the order reception apparatus 102 puts a check mark F2 in the selected checkbox F1. In FIG. 7, a state in which the animation F1a is selected is shown.

The transfer start button G1 is a button for starting the transfer of the content specified by selecting the checkbox F1. If a selection of the transfer start button G1 is received, the microcomputer 201 of the order reception apparatus 102 transfers the selected content to the terminal apparatus 130 connected with the order reception apparatus 102. The cancel button G2 is an operator for instructing stop of the transfer operation. If a selection of the cancel button G2 is received from a customer, the microcomputer 201 of the order reception apparatus 102 erases the content selection screen 40 and displays the menu detail screen 30 again.

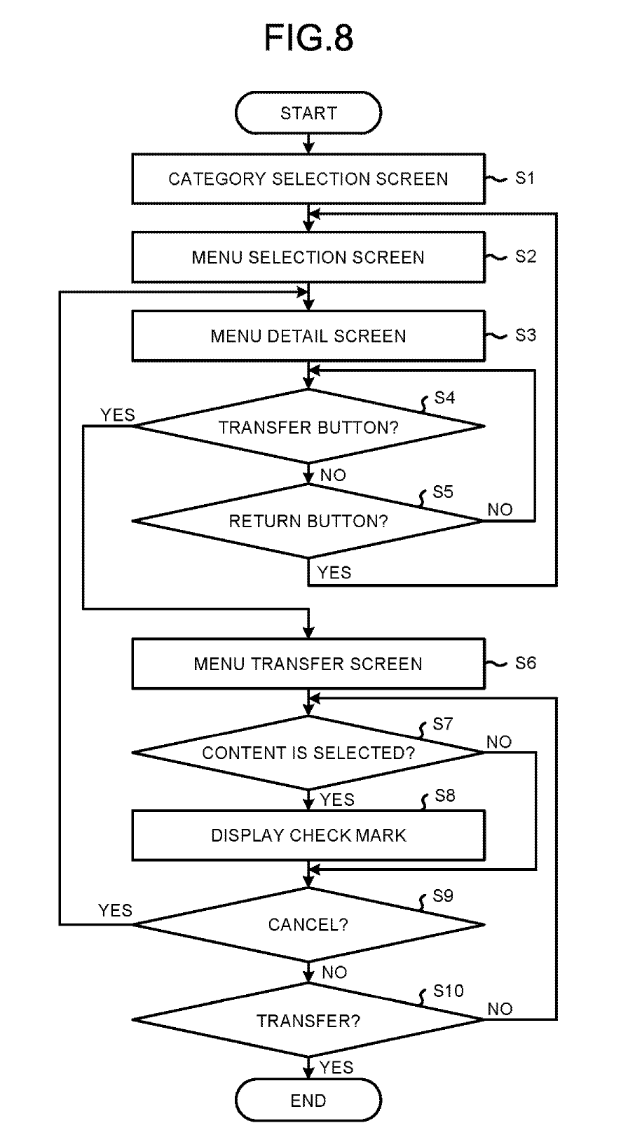

FIG. 8 is a flowchart illustrating an example of a content transfer processing executed by the microcomputer 201 of the order reception apparatus 102. The microcomputer 201 of the order reception apparatus 102 displays the category selection screen 10 (refer to FIG. 4) and waits for an input (ACT S1) If a selection of the category selection display A on the category selection screen 10 is received, the microcomputer 201 of the order reception apparatus 102 displays the menu selection screen 20 (refer to FIG. 5) (ACT S2). Further, if a selection of the menu information 54 on the menu selection screen 20 is received, the microcomputer 201 of the order reception apparatus 102 displays the menu detail screen 30 (refer to FIG. 6) (ACT S3).

Then, the microcomputer 201 of the order reception apparatus 102 determines whether or not the transfer button E1 on the menu detail screen 30 is selected (ACT S4) If the transfer button E1 is not selected (NO in ACT S4), the microcomputer 201 of the order reception apparatus 102 proceeds to carry out the processing in ACT S5. If the transfer button E1 is selected (YES in ACT S4), the microcomputer 201 of the order reception apparatus 102 displays the content selection screen 40 (ACT S6).

In ACT S5, the microcomputer 201 of the order reception apparatus 102 determines whether or not the return button 52 is selected (ACT S5). If the return button 52 is not selected (NO in ACT S5) the microcomputer 201 of the order reception apparatus 102 returns to ACT S4 and waits for input. If the return button 52 is selected (YES in ACT S5), the microcomputer 201 of the order reception apparatus 102 erases the menu detail screen 30, and returns to ACT S2 to display the menu selection screen 20. Thereby, a customer can select a menu again or request a checkout processing.

Then, the microcomputer 201 of the order reception apparatus 102 determines whether or not the content is selected from the content selection screen 40 (ACT S7). If the content is not selected (NO in ACT S7), the microcomputer 201 of the order reception apparatus 102 proceeds to carry out the processing in ACT S9. If the content is selected (YES in ACT S7), the microcomputer 201 of the order reception apparatus 102 puts the check mark F2 in the checkbox E1 (ACT S8).

In ACT S9, the microcomputer 201 of the order reception apparatus 102 determines whether or not the cancel button G2 is selected (ACT S9). If the cancel button 02 is selected (YES in ACT S9), the microcomputer 201 of the order reception apparatus 102 erases the content selection screen 40, and returns to ACT S3 to display the menu detail screen 30. If the cancel button G2 is not selected (NO in ACT S9), the microcomputer 201 of the order reception apparatus 102 proceeds to carry out the processing in ACT S10.

In ACT S10, the microcomputer 201 of the order reception apparatus 102 determines whether or not the transfer start button 51 is selected (ACT S10). If the transfer start button G1 is selected (YES in ACT S10), the microcomputer 201 of the order reception apparatus 102 transfers the selected content and then ends the processing. If the transfer start button G1 is not selected (NO in ACT S10), the microcomputer 201 of the order reception apparatus 102 returns to ACT S7 and waits for input.

In this way, according to the order reception apparatus 102 of the present embodiment, since the content is transferred to the terminal apparatus 130 of the customer, usability of the order reception apparatus 102 can be improved.

The basic OS 173 and the program 172 executed by the order reception apparatus 102 of the present embodiment are recorded in a computer-readable recording medium such as a CD-ROM, flexible disk (FD), CD-R, DVD (Digital Versatile Disk) and the like in the form of installable or executable form.

In addition, the basic OS 173 and the program 172 executed by the order reception apparatus 102 of the present embodiment may be stored in a computer connected with a network such as the Internet, and downloaded via the network. Further, the basic OS 173 and the program 172 executed by the order reception apparatus 102 of the present embodiment may also be provided or distributed via a network such as the internet.

In the present embodiment, the animation F1a serving as a video data, the recipe F1b, the foodstuff information F1c and the advertisement F1d are described as a content. However, the preset invention is not limited to this, and contents created in various formats may also be used. For example, an image data and a text data such as a game, a sound data, campaign information or a discount coupon may also be used.

In addition, in the present embodiment, the radio repeater 107 is described as the wireless communication module. However, the present invention is not limited to this. A short distance wireless communication interface such as NFC or Bluetooth (registered trademark) and the like may also be used as the wireless communication module.

Moreover, in the present embodiment, it is described that the animation F1a, the recipe F1b, the foodstuff information F1c and the like are transferred as a content. Advertisement content may be added to the contents and transferred when the contents are transferred. For example, the advertisement content may be added at the beginning of the animation F1a, the middle of the animation F1a or the end of the animation F1a. Alternatively, a trademark of a store such as name of a store and a service mark and the like may also be added to the content of the animation F1a, the recipe F1b, the foodstuff information F1c and the like to display it together with the content. Further, advertisement content including sound data may also be added to the contents of the animation F1a, the recipe F1b, the foodstuff information F1c and the like.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An order reception apparatus, which displays a first selection screen for receiving an order of a menu item, comprising:
a reception module configured to receive a selection operation of the menu item on the first selection screen by a customer;
a connection module configured to be connectable to an external apparatus; and
a transfer module configured to transfer a content relating to the menu item the selection of which is received by the reception module on the first selection screen to the external apparatus with the connection module.

2. The order reception apparatus according to claim 1, further comprising a selection module configured to select a content as a transfer target within contents relating to the menu item the selection of which is received by the reception module, wherein the transfer module transfers the content selected by the selection module to the external apparatus.

3. The order reception apparatus according to claim 2, wherein the selection module displays a second selection screen displaying each piece of the contents relating to the menu item the selection of which is received by the reception module, and sets the content of which the selection is received by the reception module on the second selection screen as the transfer target.

4. The order reception apparatus according to claim 1, wherein the transfer module adds advertisement content to the content selected, and transfers the content with the advertisement content to the external apparatus.

5. The order reception apparatus according to claim 1, wherein the content is one of animation data, image data, sound data and text data relating to the menu item.

6. A method for transmitting order of a menu item received by an order reception apparatus, including;
displaying a first selection screen on which menu items are displayed;
receiving order of a menu item on the first selection screen selected by a customer;
connecting the order reception apparatus with an external apparatus; and
transferring a content relating to the menu item of which the order is received on the first selection screen to the connected external apparatus.
